(19) United States
(12) Patent Application Publication
(10) Pub. No.: US 2023/0297337 A1
(43) Pub. Date: Sep. 21, 2023

(54) SYSTEM AND METHOD FOR ACCELERATING TRAINING OF DEEP LEARNING NETWORKS

(71) Applicant: THE GOVERNING COUNCIL OF THE UNIVERSITY OF TORONTO, Toronto (CA)

(72) Inventors: Omar MOHAMED AWAD, Toronto (CA); Mostafa MAHMOUD, Toronto (CA); Andreas MOSHOVOS, North York (CA)

(21) Appl. No.: 18/005,717

(22) PCT Filed: Jul. 19, 2021
(86) PCT No.: PCT/CA2021/050994

§ 371 Date: Jan. 17, 2023

Related U.S. Application Data
(60) Provisional application No. 63/054,502, filed on Jul. 21, 2020.

(51) Int. Cl. G06F 7/544; G06F 7/556

(52) U.S. Cl. CPC G06F 7/5443; G06F 7/556

(57) ABSTRACT

A system and method for accelerating multiply-accumulate (MAC) floating-point units during training of deep learning networks. The method including: receiving a first input data stream A and a second input data stream B; adding exponents of the first data stream A and the second data stream B in pairs to produce product exponents; determining a maximum exponent using a comparator; determining a number of bits by which each significand in the second data stream has to be shifted prior to accumulation by adding product exponent deltas to the corresponding term in the first data stream and using an adder tree to reduce the operands in the second data stream into a single partial sum; adding the partial sum to a corresponding aligned value using the maximum exponent to determine accumulated values; and outputting the accumulated values.

### TECHNICAL FIELD

The following relates generally to deep learning networks and more specifically to a system and method for accelerating training of deep learning networks.

### BACKGROUND

The pervasive applications of deep learning and the end of Dennard scaling have been driving efforts for accelerating deep learning inference and training. These efforts span the full system stack, from algorithms, to middleware and hardware architectures. Training is a task that includes inference as a subtask. Training is a compute- and memory-intensive task often requiring weeks of compute time.

### SUMMARY

In an aspect, there is provided a method for accelerating multiply-accumulate (MAC) floating-point units during training or inference of deep learning networks, the method comprising: receiving a first input data stream A and a second input data stream B; adding exponents of the first data stream A and the second data stream B in pairs to produce product exponents; determining a maximum exponent using a comparator; determining a number of bits by which each significand in the second data stream has to be shifted prior to accumulation by adding product exponent deltas to the corresponding term in the first data stream and using an adder tree to reduce the operands in the second data stream into a single partial sum; adding the partial sum to a corresponding aligned value using the maximum exponent to determine accumulated values; and outputting the accumulated values.

In a particular case of the method, determining the number of bits by which each significand in the second data stream has to be shifted prior to accumulation includes skipping ineffectual terms mapped outside a defined accumulator width.

In another case of the method, each significand comprises a signed power of 2.

In yet another case of the method, adding the exponents and determining the maximum exponent are shared among a plurality of MAC floating-point units.

In yet another case of the method, the exponents are set to a fixed value.

In yet another case of the method, the method further comprising storing floating-point values in groups, and wherein the exponents deltas are encoded as a difference from a base exponent.

In yet another case of the method, the base exponent is a first exponent in the group.

In yet another case of the method, using the comparator comprises comparing the maximum exponent to a threshold of an accumulator bit-width.

In yet another case of the method, the threshold is set to ensure model convergence.

In yet another case of the method, the threshold is set to within 0.5% of training accuracy.

In another aspect, there is provided a system for accelerating multiply-accumulate (MAC) floating-point units during training or inference of deep learning networks, the system comprising one or more processors in communication with data memory to execute: an input module to receive a first input data stream A and a second input data stream B; an exponent module to add exponents of the first data stream A and the second data stream B in pairs to produce product exponents, and to determine a maximum exponent using a comparator; a reduction module to determine a number of bits by which each significand in the second data stream has to be shifted prior to accumulation by adding product exponent deltas to the corresponding term in the first data stream and use an adder tree to reduce the operands in the second data stream into a single partial sum; and an accumulation module to add the partial sum to a corresponding aligned value using the maximum exponent to determine accumulated values, and to output the accumulated values.

In a particular case of the system, determining the number of bits by which each significand in the second data stream has to be shifted prior to accumulation includes skipping ineffectual terms mapped outside a defined accumulator width.

In another case of the system, each significand comprises a signed power of 2.

In yet another case of the system, the exponent module, the reduction module, and the accumulation module are located on a processing unit and wherein adding the exponents and determining the maximum exponent are shared among a plurality of processing units.

In yet another case of the system, the plurality of processing units are configured in a tile arrangement.

In yet another case of the system, processing units in the same column share the same output from the exponent module and processing units in the same row share the same output from the input module.

In yet another case of the system, the exponents are set to a fixed value.

In yet another case of the system, the system further comprising storing floating-point values in groups, and wherein the exponents deltas are encoded as a difference from a base exponent, and wherein the base exponent is a first exponent in the group.

In yet another case of the system, using the comparator comprises comparing the maximum exponent to a threshold of an accumulator bit-width, where the threshold is set to ensure model convergence.

In yet another case of the system, the threshold is set to within 0.5% of training accuracy.

These and other aspects are contemplated and described herein. It will be appreciated that the foregoing summary sets out representative aspects of embodiments to assist skilled readers in understanding the following detailed description.

### DESCRIPTION OF THE DRAWINGS

A greater understanding of the embodiments will be had with reference to the Figures, in which:

FIG. 1 is a schematic diagram of a system for accelerating training of deep learning networks, in accordance with an embodiment;

FIG. 2 is a schematic diagram showing the system of FIG. 1 and an exemplary operating environment;

FIG. 3 is a flow chart of a method for accelerating training of deep learning networks, in accordance with an embodiment;

FIG. 4 shows an illustrative example of zero and out-of-bounds terms;

FIG. 5 shows an example of a processing element including an exponent module, a reduction module, and an accumulation module, in accordance with the system of FIG. 1;

FIG. 6 shows an example of exponent distribution of layer Conv2d_8 in epochs 0 and 89 of training ResNet34 on ImageNet;

FIG. 7 illustrates another embodiment a processing element, in accordance with the system of FIG. 1;

FIG. 8 shows an example of a 2×2 tile of processing elements, in accordance with the system of FIG. 1;

FIG. 9 shows an example of values being blocked channel-wise;

FIG. 10 shows performance improvement with the system of FIG. 1 relative to a baseline;

FIG. 11 shows total energy efficiency of the system of FIG. 1 over the baseline architecture for each model;

FIG. 12 shows energy consumed by the system of FIG. 1 normalized to the baseline as a breakdown across three main components: compute logic, off-chip and on-chip data transfers;

FIG. 13 shows a breakdown of terms the system of FIG. 1 can skip;

FIG. 14 shows speedup for each of three phases of training;

FIG. 15 shows speedup of the system of FIG. 1 over the baseline over time and throughout the training process;

FIG. 16 shows speedup of the system of FIG. 1 over the baseline with varying a number of rows per tile;

FIG. 17 shows effects of varying a number of rows for each cycle;

FIG. 18 shows accuracy of training ResNet18 by emulating the system of FIG. 1 in PlaidML; and

FIG. 19 shows performance of the system of FIG. 1 with per layer profiled accumulator width versus fixed accumulator width.

### DETAILED DESCRIPTION

Embodiments will now be described with reference to the figures. For simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

Any module, unit, component, server, computer, terminal or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Any application or module herein described may be implemented using computer readable/executable instructions that may be stored or otherwise held by such computer readable media.

During training of some deep learning networks, a set of annotated inputs, for which the desired output is known, are processed by repeatedly performing a forward and backward pass. The forward pass performs inference whose output is initially inaccurate. However, given that the desired outputs are known, the training can calculate a loss, a metric of how far the outputs are from the desired ones. During the backward pass, this loss is used to adjust the network's parameters and to have it slowly converge to its best possible accuracy.

Numerous approaches have been developed to accelerate training, and fortunately often they can be used in combination. Distributed training partitions the training workload across several computing nodes taking advantage of data, model, or pipeline parallelism. Timing communication and computation can further reduce training time. Dataflow optimizations to facilitate data blocking and to maximize data reuse reduces the cost of on- and off-chip accesses within the node maximizing reuse from lower cost components of the memory hierarchy. Another family of methods reduces the footprint of the intermediate data needed during training. For example, in the simplest form of training, all neuron values produced during the forward pass are kept to be used during backpropagation. Batching and keeping only one or a few samples instead reduces this cost. Lossless and lossy compression methods further reduce the footprint of such data. Finally, selective backpropagation methods alter the backward pass by propagating loss only for some of the neurons thus reducing work.

On the other hand, the need to boost energy efficiency during inference has led to techniques that increase computation and memory needs during training. This includes works that perform network pruning and quantization during training. Pruning zeroes out weights and thus creates an opportunity for reducing work and model size during inference. Quantization produces models that use shorter and more energy efficient to compute with datatypes such as 16b, 8b or 4b fixed-point values. Parameter Efficient Training and Memorized Sparse Backpropagation are examples of pruning methods. PACT and outlier-aware quantization are training time quantization methods. Network architecture search techniques also increase training time as they adjust the model's architecture.

Despite the above, the need to further accelerate training both at the data center and at the edge remains unabated. Operating and maintenance costs, latency, throughput, and node count are major considerations for data centers. At the edge energy and latency are major considerations where training may be primarily used to refine or augment already trained models. Regardless of the target application, improving node performance would be highly advantageous. Accordingly, the present embodiments could complement existing training acceleration methods. In general, the bulk of the computations and data transfers during training is for performing multiply-accumulate operations (MAC) during the forward and backward passes. As mentioned above, compression methods can greatly reduce the cost of data transfers. Embodiments of the present disclosure target processing elements for these operations and exploit ineffectual work that occurs naturally during training and whose frequency is amplified by quantization, pruning, and selective backpropagation.

Some accelerators rely on that zeros occur naturally in the activations of many models especially when they use ReLU. There are several accelerators that target pruned models. Another class of designs benefit from reduced value ranges whether these occur naturally or result from quantization. This includes bit-serial designs, and designs that support many different datatypes such as BitFusion. Finally, another class of designs targets bit-sparsity where, by decomposing multiplication into a series of shift-and-add operations, they expose ineffectual work at the bit-level.

While the above accelerate for inference, training presents substantially different challenges. First, is the datatype. While models during inference work with fixed-point values of relatively limited range, the values training operates upon tend to be spread over a large range. Accordingly, training implementations use floating-point arithmetic with single-precision IEEE floating point arithmetic (FP32) being sufficient for virtually all models. Other datatypes that facilitate the use of more energy- and area-efficient multiply-accumulate units compared to FP32 have been successfully used in training many models. These include bfloat 16, and 8b or smaller floating-point formats. Moreover, since floating-point arithmetic is a lot more expensive than integer arithmetic, mixed datatype training methods use floating-point arithmetic only sparingly. Despite these proposals, FP32 remains the standard fall-back format, especially for training on large and challenging datasets. As a result of its limited range and the lack of an exponent, the fixed-point representation used during inference gives rise to zero values (too small a value to be represented), zero bit prefixes (small value that can be represented), and bit sparsity (most values tend to be small and few are large) that the aforementioned inference accelerators rely upon. FP32 can represent much smaller values, its mantissa is normalized, and whether bit sparsity exists has not generally been demonstrated.

Additionally, a challenge is the computation structure. Inference operates on two tensors, the weights and the activations, performing per layer a matrix/matrix or matrix/vector multiplication or pairwise vector operations to produce the activations for the next layer in a feed-forward fashion. Training includes this computation as its forward pass which is followed by the backward pass that involves a third tensor, the gradients. Most importantly, the backward pass uses the activation and weight tensors in a different way than the forward pass, making it difficult to pack them efficiently in memory, more so to remove zeros as done by inference accelerators that target sparsity. Additionally, related to computation structure, is value mutability and value content. Whereas in inference the weights are static, they are not so during training. Furthermore, training initializes the network with random values which it then slowly adjusts. Accordingly, one cannot necessarily expect the values processed during training to exhibit similar behavior such as sparsity or bit-sparsity. More so for the gradients, which are values that do not appear at all during inference.

The present inventors have demonstrated that a large fraction of the work performed during training can be viewed as ineffectual. To expose this ineffectual work, each multiplication was decomposed into a series of single bit multiply-accumulate operations. This reveals two sources of ineffectual work: First, more than 60% of the computations are ineffectual since one of the inputs is zero. Second, the combination of the high dynamic range (exponent) and the limited precision (mantissa) often yields values which are non-zero, yet too small to affect the accumulated result, even when using extended precision (e.g., trying to accumulate 2⁻⁶⁴ into 2⁶⁴).

The above observation led the present inventors to consider whether it is possible to use bit-skipping (bitserial where zero bits are skipped-over) processing to exploit these two behaviors. For inference, Bit-Pragmatic is a data-parallel processing element that performs such bit-skipping of one operand side, whereas Laconic does so for both sides. Since these methods target inference only, they work with fixed-point values. Since there is little bit-sparsity in the weights during training, converting a fixed-point design to floating-point is a non-trivial task. Simply converting Bit-Pragmatic into floating point resulted in an area-expensive unit which performs poorly under ISO-compute area constraints. Specifically, compared to an optimized Bfloat16 processing element that performs 8 MAC operations, under ISO-compute constraints, an optimized accelerator configuration using the Bfloat16 Bit-Pragmatic PEs is on average 1.72×slower and 1.96×less energy efficient. In the worst case, the Bfloat16 bit-pragmatic PE was 2.86×slower and 3.2×less energy efficient. The Bfloat16 BitPragmatic PE is 2.5×smaller than the bit-parallel PE, and while one can use more such PEs for the same area, one cannot fit enough of them to boost performance via parallelism as required by all bit-serial and bit-skipping designs.

The present embodiments (informally referred to as FPRaker) provide a processing tile for training accelerators which exploits both bit-sparsity and out-of-bounds computations. FPRaker, in some cases, comprises several adder-tree based processing elements organized in a grid so that it can exploit data reuse both spatially and temporally. The processing elements multiply multiple value pairs concurrently and accumulate their products into an output accumulator. They process one of the input operands per multiplication as a series of signed powers of two, hitherto referred to as terms. The conversion of that operand into powers of two can be performed on the fly; all operands are stored in floating point form in memory. The processing elements take advantage of ineffectual work that stems either from mantissa bits that were zero or from out-of-bounds multiplications given the current accumulator value. The tile is designed for area efficiency. In some cases for the tile, the processing element limits the range of powers-of-two that they can be processed simultaneously greatly reducing the cost of its shift-and-add components. Additionally, in some cases for the tile, a common exponent processing unit is used that is time-multiplexed among multiple processing elements. Additionally, in some cases for the tile, power-of-two encoders are shared along the rows. Additionally, in some cases for the tile, per processing element buffers reduce the effects of work imbalance across the processing elements. Additionally, in some cases for the tile, PE implements a low cost mechanism for eliminating out-of-range intermediate values.

Additionally, in some cases, the present embodiments can advantageously provide at least some of the following characteristics:
Not affecting numerical accuracy results produced adhere to floating-point arithmetic used during training.
Skips ineffectual operations that would result from zero mantissa bits and from out-of-range intermediate values.
Despite individual MAC operations of more than one cycle, the computational throughput is higher compared to other floating-point units; given that the processing elements are much smaller per area.
Supports shorter mantissa lengths, thus providing enhanced benefits for training with mixed or shorter datatypes; without generally requiring training be universally applicable to all models.
Allows the choice of which tensor input to process serially per layer; allowing targeting those tensors that have more sparsity depending on the layer and the pass (forward or backward).

The present embodiments also advantageously provide a low-overhead memory encoding for floating-point values that rely on the value distribution that is typical of deep learning training. The present inventors have observed that consecutive values across channels have similar values and thus exponents. Accordingly, the exponents can be encoded as deltas for groups of such values. These encodings can be used when storing and reading values of chip, thus further reducing the cost of memory transfers.

Through example experiments, the present inventors determined the following experimental observations:
While some neural networks naturally exhibit zero values (sparsity) during training, unless pruning is used, this is generally limited to the activations and the gradients.
Term-sparsity generally exists in all tensors including the weights and is much higher than sparsity.
Compared to an accelerator using optimized bit-parallel FP32 processing elements and that can perform 4K bfloat16 MACs per cycle, a configuration that uses the same compute area to deploy the PEs of the present embodiments is 1.5× faster and 1.4× more energy efficient.
Performance benefits with the present embodiments is generally stable throughout the training process for all three major operations.
The present embodiments can be used in conjunction with training methods that specify a different accumulator precision to be used per layer. There it can improve performance versus using an accumulator with a fixed width significand by 38% for ResNet18.

The present inventors measured work reduction that was theoretically possible with two related approaches:
1) by removing all MACs where at least one of the operands are zero (value sparsity, or simply sparsity), and
2) by processing only the non-zero bits of the mantissa of one of the operands (bit sparsity).

Example experiments were performed to examine performance of the present embodiments on different applications. TABLE 1 lists the models studied in the example experiments. ResNet18-Q is a variant of ResNet18 trained using PACT, which quantizes both activations and weights down to four-bits (4b) during training. ResNet50-S2 is a variant of ResNet50 trained using dynamic sparse reparameterization, which targets sparse learning that maintain high weight sparsity throughout the training process while achieving accuracy levels comparable to baseline training. SNLI performs natural language inference and comprises of fully-connected, LSTM-encoder, ReLU, and dropout layers. Image2Text is an encoder-decoder model for image-to-markup generation. Three models of different tasks were examined from a MLPerf training benchmark: 1) Detectron2: an object detection model based on Mask R-CNN, 2) NCF: a model for collaborative filtering, and 3) Bert: a transformer-based model using attention. For measurement, one randomly selected batch per epoch was sampled over as many epochs as necessary to train the network to its originally reported accuracy (up to 90 epochs were enough for all).

TABLE 1

| Model | Application | Dataset |
|---|---|---|
| SqueezeNet 1.1 | Image Classification | ImageNet |
| VGG16 | Image Classification | ImageNet |
| ResNet18-Q | Image Classification | ImageNet |
| ResNet50-S2 | Image Classification | ImageNet |
| SNLI | Natural Language Infer. | SNLI Corpus |
| Image2Text | Image-to-Text Conversion | im2latex-100 k |
| Detectron2 | Object Detection | COCO |
| NCF | Recommendation | WMT17 |
| Bert | Language Translation | ml-20 m |

Generally, the bulk of computational work during training is due to three major operations per layer:

$$Z = I \cdot W \qquad ( 1 )$$

$$\frac{\partial E}{\partial I} = {W}^{T} \cdot \frac{\partial E}{\partial Z} \qquad ( 2 )$$

$$\frac{\partial E}{\partial W} = I \cdot \frac{\partial E}{\partial Z} \qquad ( 3 )$$

For convolutional layers, Equation (1), above, describes the convolution of activations (I) and weights (W) that produces the output activations (Z) during forward propagation. There the output Z passes through an activation function before used as input for the next layer. Equation (1) and Equation (3), above, describe the calculation of the activation (∂E/∂t) and weight (∂E/∂W) gradients respectively in the backward propagation. Only the activation gradients are back-propagated across layers. The weight gradients update the layer's weights once per batch. For fully-connected layers the equations describe several matrix-vector operations. For other operations they describe vector operations or matrix-vector operations. For clarity, in this disclosure, gradients are referred to as G. The term term-sparsity is used herein to signify that for these measurements the mantissa is first encoded into signed powers of two using Canonical encoding which is a variation of Booth-encoding. This is because bit-skipping processing for the mantissa.

In an example, activations in image classification networks exhibit sparsity exceeding 35% in all cases. This is expected since these networks generally use the ReLU activation function which clips negative values to zero. However, weight sparsity is typically low and only some of the classification models exhibit sparsity in their gradients. For the remaining models, however, such as those for natural language processing, value sparsity may be very low for all three tensors. Regardless, since models do generally exhibit some sparsity, the present inventors investigated whether such sparsity could be exploited during training. This is a non-trivial task as training is different than inference and exhibits dynamic sparsity patterns on all tensors and different computation structure during the backward pass. It was found that, generally, all three tensors exhibit high term-sparsity for all models regardless of the target application. Given that term-sparsity is more prevalent than value sparsity, and exists in all models, the present embodiments exploit such sparsity during training to enhance efficiency of training the models.

An ideal potential speedup due to reduction in the multiplication work can be achieved through skipping the zero terms in the serial input. The potential speedup over the baseline can be determined as:

$$Potential speedup = \frac{\# MAC operations}{term sparsity \times \# MAC operations} \qquad ( 4 )$$

The present embodiments take advantage of bit sparsity in one of the operands used in the three operations performed during training (Equations (1) through (3) above) all of which are composed of many MAC operations. Decomposing MAC operations into a series of shift-and-add operations can expose ineffectual work, providing the opportunity to save energy and time.

To expose ineffectual work during MAC operations, the operations can be decomposed into a series of “shift and add” operations. For multiplication., let A=2^{Ae}×Aₘ, and B=2^{Be}×Bₘ, be two values in floating point, both represented as an exponent (Aₑ and Bₑ) and a significand (Aₘ and Bₘ), which is normalized and includes the implied “1.”. Conventional floating-point units perform this multiplication in a single step (sign bits are XORed):

A×B=2^{A}^{ₑ}^{+B}^{ₑ}×(Aₘ×Bₘ)=(Aₘ×Bₘ)<<(Aₑ+Bₑ) (5)

By decomposing Aₘ into a series p of signed powers of two Aₘ^{p} where A=ΣₚAₘ^{p} and Aₘ^{p}=±2ⁱ, the multiplication can be performed as follows:

A×B=(ΣₚAₘ^{p}×Bₘ)<<(Aₑ+Bₑ)=ΣₚBₘ<<(Aₘ^{p}+Aₑ+Bₑ) (6)

For example, if Aₘ=1.0000001 b, Aₑ=10b, Bₘ=1.1010011b and Bₑ=11b, then A×B can be performed as two shift-and-add operations of [symbol] and [symbol] . A conventional multiplier would process all bits of Aₘ despite performing ineffectual work for the six bits that are zero.

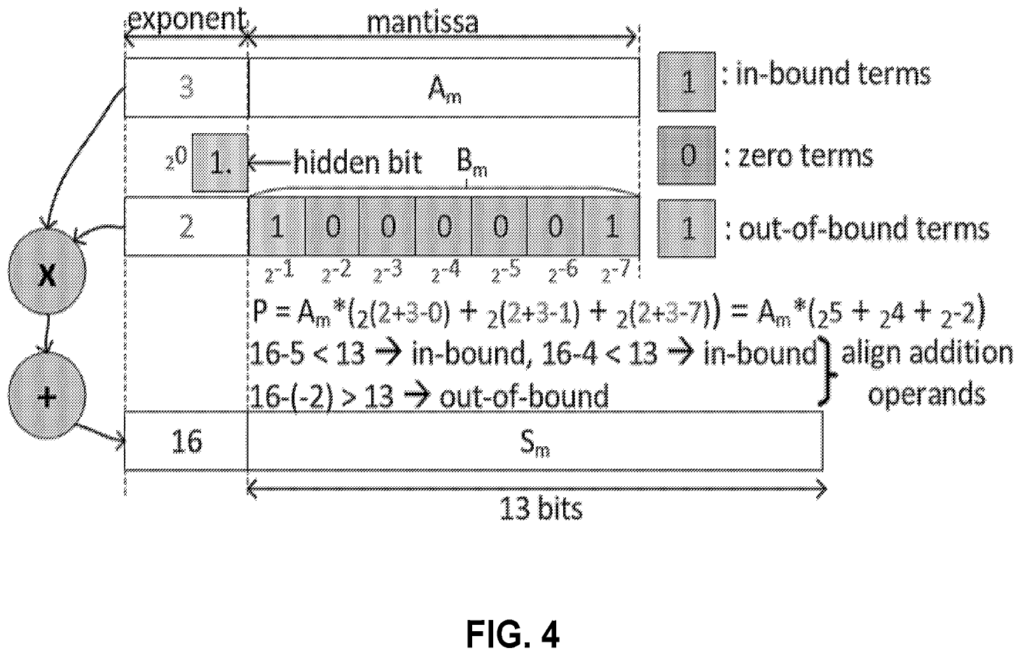

However, the above decomposition exposes further ineffectual work that conventional units perform as a result of the high dynamic range of values that floating point seeks to represent. Informally, some of the work done during the multiplication will result in values that will be out-of-bounds given the accumulator value. To understand why this is the case, consider not only the multiplication but also the accumulation. Assume that the product A×B will be accumulated into a running sum S and Sₑ is much larger than Aₑ+Bₑ. It will not be possible to represent the sum S+A×B given the limited precision of the mantissa. In other cases, some of the “shift-and-add” operations would be guaranteed to fall outside the mantissa even when considering the increased mantissa length used to perform rounding, i.e., partial swamping. FIG. 4 shows an illustrative example of the zero and out-of-bounds terms. A conventional pipelined MAC unit can at best power-gate the multiplier and accumulator after comparing the exponents and only when the whole multiplication result falls out of range. However, it cannot use this opportunity to reduce cycle count. By decomposing the multiplication into several simpler operations, the present embodiments can terminate the operation in a single cycle given that the bits are processed from the most to the least significand, and thus boost performance by initiating another MAC earlier. The same is true when processing multiple A×B products in parallel in an adder-tree processing element. A conventional adder-tree based MAC unit can potentially power-gate the multiplier and the adder tree branches corresponding to products that will be out-of-bounds. The cycle will still be consumed. Advantageously, in the present embodiments, a shift-and-add based approach will be able to terminate such products in a single cycle and advance others in their place.

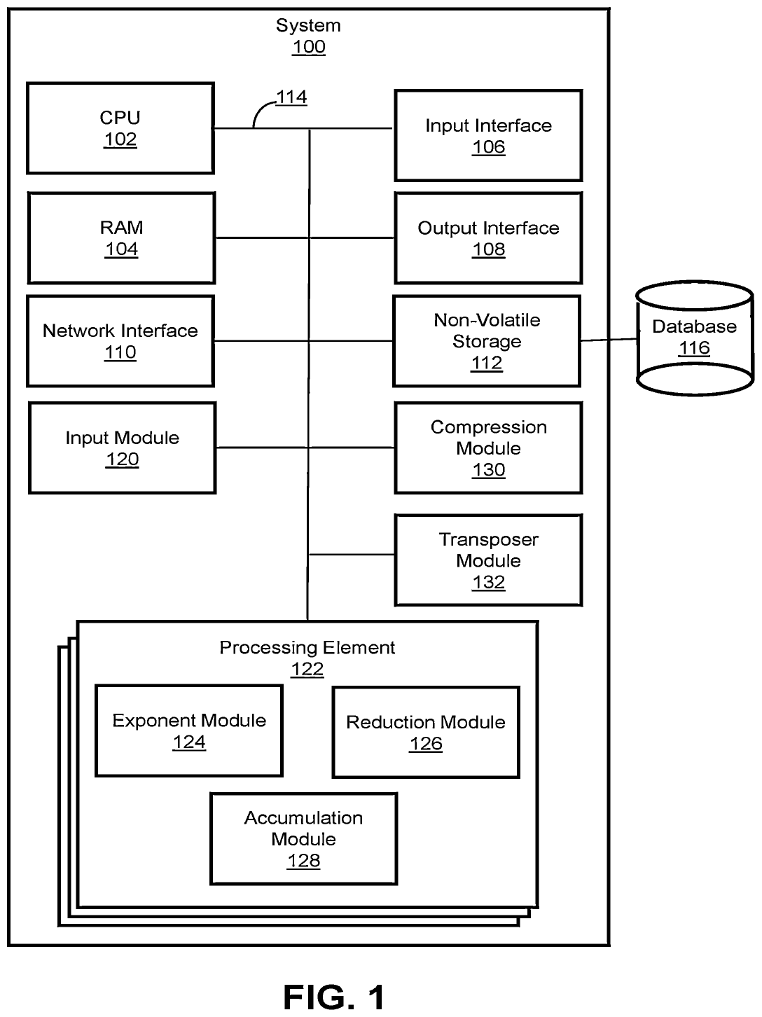

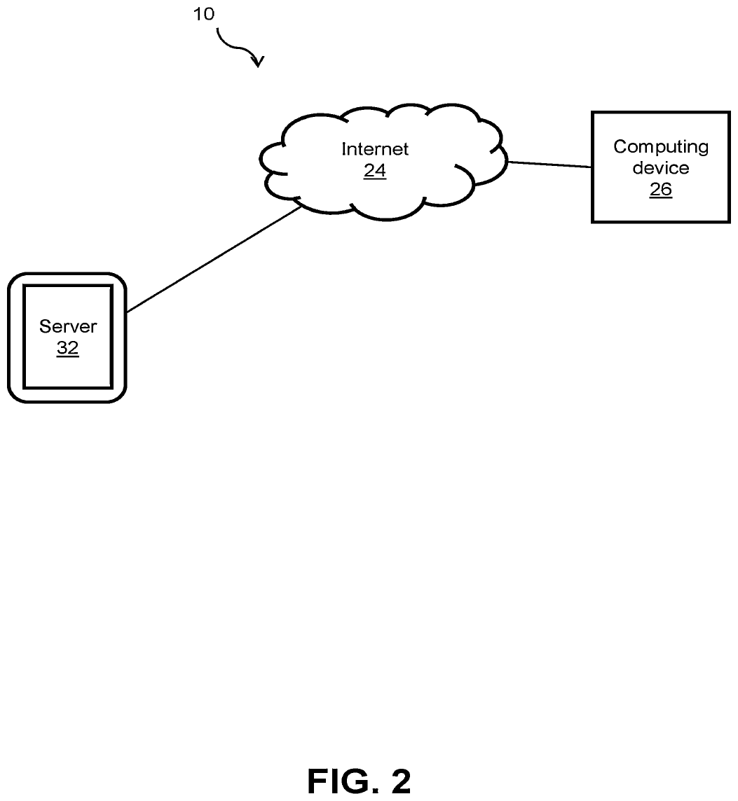

Referring now to FIG. 1 and FIG. 2, a system 100 for accelerating training of deep learning networks (informally referred to as “FPRaker”), in accordance with an embodiment, is shown. In this embodiment, the system 100 is run on a computing device 26 and accesses content located on a server 32 over a network 24, such as the internet. In further embodiments, the system 100 can be run only on the device 26 or only on the server 32, or run and/or distributed on any other computing device; for example, a desktop computer, a laptop computer, a smartphone, a tablet computer, a server, a smartwatch, distributed or cloud computing device(s), or the like. In some embodiments, the components of the system 100 are stored by and executed on a single computer system. In other embodiments, the components of the system 100 are distributed among two or more computer systems that may be locally or remotely distributed.

FIG. 1 shows various physical and logical components of an embodiment of the system 100. As shown, the system 100 has a number of physical and logical components, including a processing unit 102 (comprising one or more processors), random access memory (“RAM”) 104, an input interface 106, an output interface 108, a network interface 110, non-volatile storage 112, and a local bus 114 enabling processing unit 102 to communicate with the other components. The processing unit 102 can execute or direct execution of various modules, as described below in greater detail. RAM 104 provides relatively responsive volatile storage to the processing unit 102. The input interface 106 enables an administrator or user to provide input via an input device, for example a keyboard and mouse. The output interface 108 outputs information to output devices, for example, a display and/or speakers. The network interface 110 permits communication with other systems, such as other computing devices and servers remotely located from the system 100, such as for a typical cloud-based access model. Non-volatile storage 112 stores the operating system and programs, including computer-executable instructions for implementing the operating system and modules, as well as any data used by these services. Additional stored data, as described below, can be stored in a database 116. During operation of the system 100, an operating system, the modules, and the related data may be retrieved from the non-volatile storage 112 and placed in RAM 104 to facilitate execution.

In an embodiment, the system 100 includes one or more modules and one or more processing elements (PEs) 122. In some cases, the PEs can be combined into tiles. In an embodiment, the system 100 includes an input module 120, a compression module 130, and a transposer module 132. Each processing element 122 includes a number of modules, including an exponent module 124, a reduction module 126, and an accumulation module 128. In some cases, some of the above modules can be run at least partially on dedicated or separate hardware, while in other cases, at least some of the functions of the some of the modules are executed on the processing unit 102.

The input module 120 receives two input data streams to have MAC operations performed on them, respectively A data and B data.

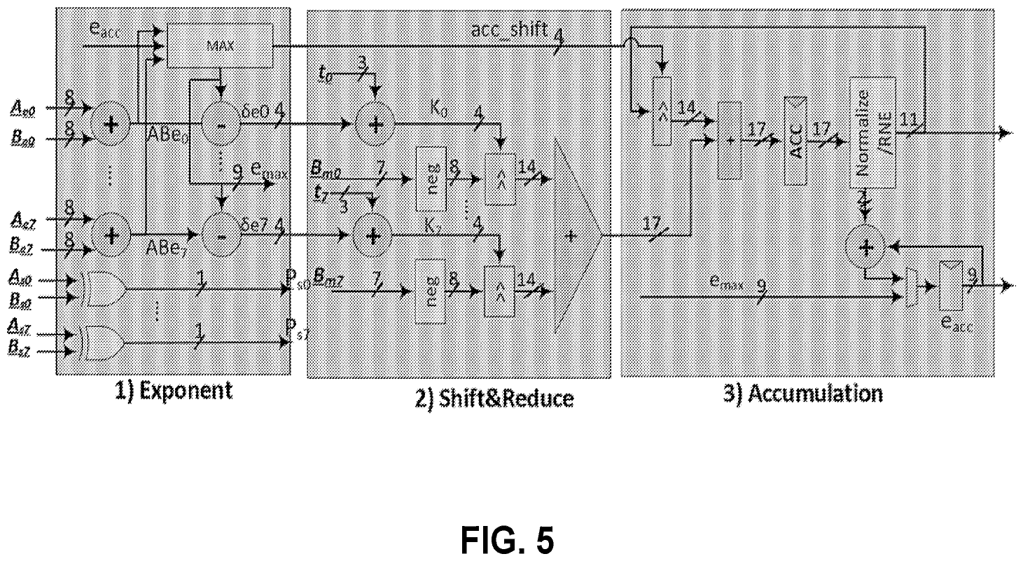

The PE 122 performs the multiplication of 8 Bfloat16 (A,B) value pairs, concurrently accumulating the result into the accumulation module 128. The Bfloat16 format consists of a sign bit, followed by a biased 8b exponent, and a normalized 7b significand (mantissa). FIG. 5 shows a baseline of the PE 122 design which performs the computation in 3 blocks: the exponent module 124, the reduction module 126, and the accumulation module 128. In some cases, the 3 blocks can be performed in a single cycle. The PEs 122 can be combined to construct a more area efficient tile comprising several of the PEs 122. The significands of each of the A operands are converted on-the-fly into a series of terms (signed powers of two) using canonical encoding; e.g., A=(1.1110000) is encoded as (+2⁺¹,−2⁻⁴). This encoding occurs just before the input to the PE 122. All values stay in bfloat16 while in memory. The PE 122 will process the A values term-serially. The accumulation module 128 has an extended 13b (13-bit) significand; 1b for the leading (hidden), 9b for extended precision following the chunk-based accumulation scheme with a chunk-size of 64, plus 3b for rounding to nearest even. It has 3 additional integer bits following the hidden bit so that it can fit the worst case carry out from accumulating 8 products. In total the accumulation module 128 has 16b, 4 integer, and 12 fractional.

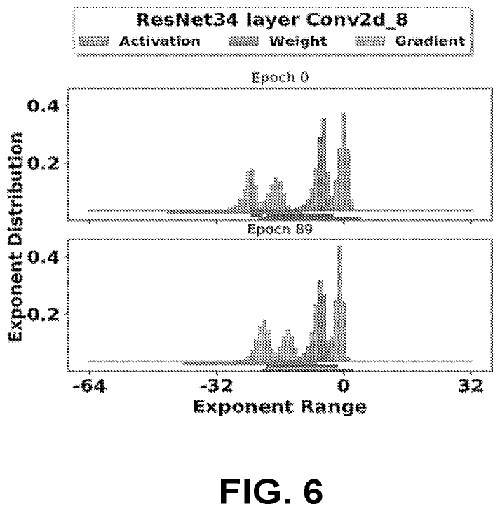

The PE 122 accepts 8 8-bit A exponents Aₑ₀, . . . , Aₑ₇, their corresponding 8 3-bit significand terms t₀, . . . , t₇ (after canonical encoding) and signs bits Aₛ₀, . . . , Aₛ₇, along with 8 8-bit B exponents Bₑ₀, . . . , Bₑ₇, their significands Bₘ₀, . . . , Bₘ₇ (as-is) and their sign bits Bₛ₀, . . . , Bₛ₇; as shown in FIG. 6. FIG. 6 shows an example of exponent distribution of layer Conv2d_8 in epochs 0 and 89 of training ResNet34 on ImageNet. FIG. 6 shows only the utilized part of the full range [−127:128] of an 8b exponent.

The exponent module 124 adds the A and B exponents in pairs to produce the exponents ABeᵢ for the corresponding products. A comparator tree takes these product exponents and the exponent of the accumulator and calculates the maximum exponent eₘₐₓ. The maximum exponent is used to align all products so that they can be summed correctly. To determine the proper alignment per product, the exponent module 124 subtracts all product exponents from eₘₐₓ calculating the alignment offsets δeᵢ. The maximum exponent is used to also discard terms that will fall out-of-bounds when accumulated. The PE 122 will skip any terms who fall outside the eₘₐₓ−12 range. Regardless, the minimum number of cycles for processing the 8 MACs will be 1 cycle regardless of value. In case one of the resulting products has an exponent larger than the current accumulator exponent, the accumulation module 128 will be shifted accordingly prior to accumulation (acc shift signal). An example of the exponent module 124 is illustrated in the first block of FIG. 5.

Since multiplication with a term amounts to shifting, the reduction module 126 determines the number of bits by which each B significand will have to be shifted by prior to accumulation. These are the 4-bit terms K₀, . . . , K₇. To calculate Kᵢ, the reduction module 126 adds the product exponent deltas (δeᵢ) to the corresponding A term tᵢ. To skip out-of-bound terms, the reduction module 126 places a comparator before each K term which compares it to a threshold of the available accumulator bit-width. The threshold can be set to ensure models converge within 0.5% of the FP32 training accuracy on ImageNet dataset. However, the threshold can be controlled effectively implementing a dynamic bit-width accumulator, which can boost performance by increasing the number of skipped “out-of-bounds” bits. The A sign bits are XORed with their corresponding B sign bits to determine the signs of the products Pₛ₀, . . . , Pₛ₇. The B significands are complemented according to their corresponding product signs, and then shifted using the offsets K₀, . . . , K₇. The reduction module 126 uses a shifter per B significand to implement the multiplication. In contrast, a conventional floating-point unit would require shifters at the output of the multiplier. Thus, the reduction module 126 effectively eliminates the cost of the multipliers. In some cases, bits that are shifted out of the accumulator range from each B operand can be rounded using round-to-nearest-even (RNE) approach. An adder tree reduces the 8 B operands into a single partial sum. An example of the reduction module 126 is illustrated in the second block of FIG. 5.

For the accumulation module 128, the resulting partial sum from the reduction module 126 is added to the correctly aligned value of the accumulator register. In each accumulation step, the accumulator register is normalized and rounded using the rounding-to-nearest-even (RNE) scheme. The normalization block updates the accumulator exponent. When the accumulator value is read out, it is converted to bfloat16 by extracting only 7b for the significand. An example of the accumulation module 128 is illustrated in the third block of FIG. 5.

In the worst case, two offsets may differ by up to 12 since the accumulation module in the example of FIG. 5 has 12 fractional bits. This means that the baseline PE 122 requires relatively large shifters and an accumulator tree that accepts wide inputs. Specifically, the PE 122 requires shifters that can shift up to 12 positions a value that is 8b (7b significant+hidden bit). Had this been integer arithmetic, it would need to accumulate 12+8=20b wide. However, since this is a floating-point unit, only the 14 most significant bits (1b hidden, 12b fractional and the sign) are accumulated. Any bits falling below this range will be included in the sticky bit, which is the least significant bit of each input operand. It is possible to greatly reduce this cost by taking advantage of the expected distribution of the exponents. For the distribution of exponents for a layer of ResNet34, the vast majority of the exponents of the inputs, the weights and the output gradients lie within a narrow range. This suggests that in the common case, the exponent deltas will be relatively small. In addition, the MSBs of the activations are guaranteed to be one (given denormals are not supported). This indicates that very often the K₀, . . . , K₇ offsets would lie within a narrow range. The system 100 takes advantage of this behavior to reduce the PE 122 area. In an example configuration, the maximum difference in among the K, offsets that can be handled in a single cycle is limited to be up to 3. As a result, the shifters need to support shifting by up to 3b and the adder now need to process 12b inputs (1b hidden, 7b+3b significant, and the sign bit). In this case, the term encoder units are modified so that they send A terms in groups where the maximum difference is 3.

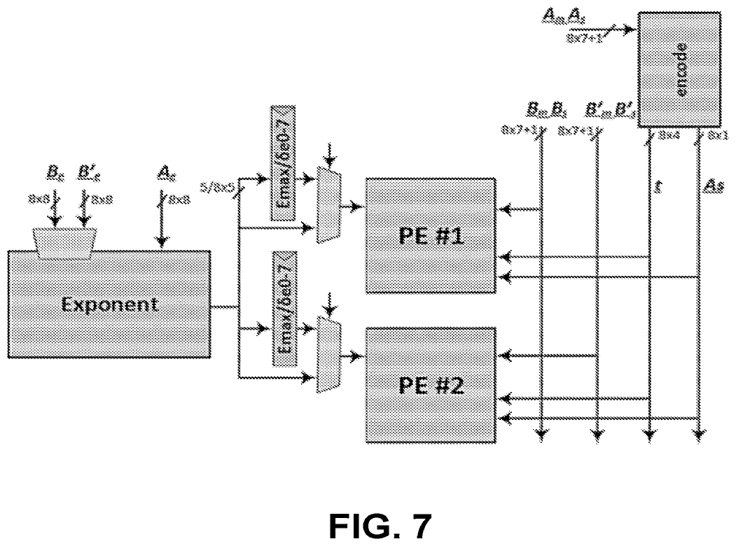

In some cases, processing a group of A values will require multiple cycles since some of them will be converted into multiple terms. During that time, the inputs to the exponent module will not change. To further reduce area, the system 100 can take advantage of this expected behavior and share the exponent block across multiple PEs 122. The decision of how many PEs 122 to share the exponent module 124 can be based on the expected bit-sparsity. The lower the bit-sparsity then higher the processing time per PE 122 and the less often it will need a new set of exponents. Hence, the more the PEs 122 that can share the exponent module 124. Since some models are highly sparse, sharing one exponent module 124 per two PEs 122 may be best in such situations. FIG. 7 illustrates another embodiment of the PE 122. The PE 122 as a whole accepts as input one set of 8 A inputs and two sets of B inputs, B and B′. The exponent module 124 can process one of (A,B) or (A,B) at a time. During the cycle when it processes (A,B) the multiplexer for PE #1 passes on the eₘₐₓ and exponent deltas directly to the PE 122. Simultaneously, these values will be latched into the registers in front of the PE 122 so that they remain constant while the PE 122 processes all terms of input A. When the exponent block processes (A,B) the aforementioned process proceeds with PE #2. With this arrangement both PEs 122 must finish processing all A terms before they can proceed to process another set of A values. Since the exponent module 124 is shared, each set of 8 A values will take at least 2 cycles to be processed (even if it contains zero terms).

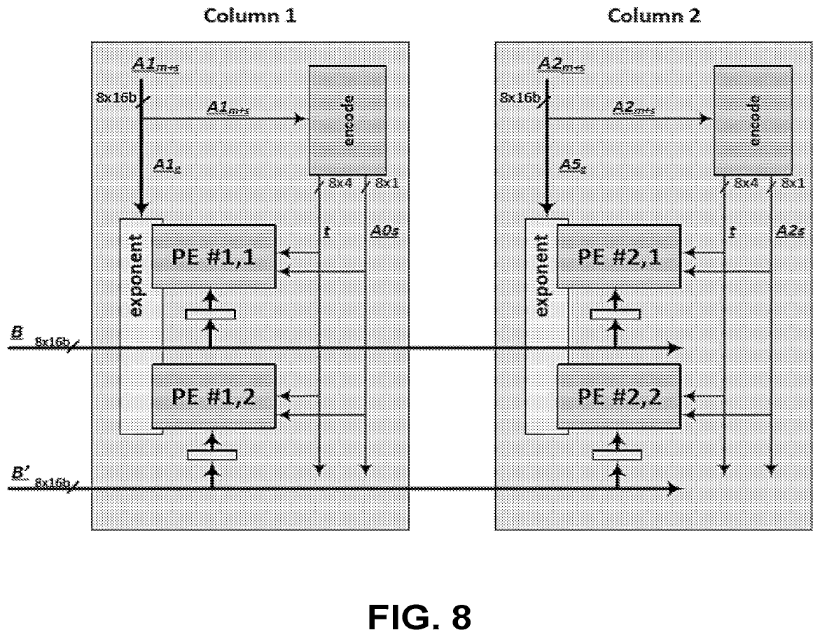

By utilizing per PE 122 buffers, it is possible to exploit data reuse temporally. To exploit data reuse spatially, the system 100 can arrange several PEs 122 into a tile. FIG. 8 shows an example of a 2×2 tile of PEs 122 and each PE 122 performs 8 MAC operations in parallel. Each pair of PEs 122 per column shares the exponent module 124 as described above. The B and B′ inputs are shared across PEs 122 in the same row. For example, during the forward pass, it can have different filters being processed by each row and different windows processed across the columns. Since the B and B′ inputs are shared, all columns would have to wait for the column with the most Ai terms to finish before advancing to the next set of B and B′ inputs. To reduce these stalls, the tile can include per B and B′ buffers. By having N such buffers per PE 122 allows the columns to be at most N sets of values ahead.

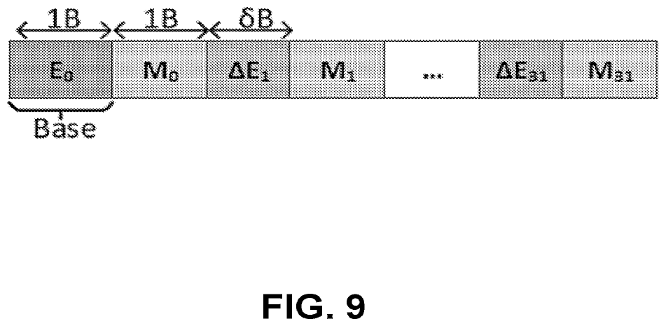

The present inventors studied spatial correlation of values during training and found that consecutive values across the channels have similar values. This is true for the activations, the weights, and the output gradients. Similar values in floating-point have similar exponents, a property which the system 100 can exploit through a base-delta compression scheme. In some cases, values can be blocked channel-wise into groups of 32 values each, where the exponent of the first value in the group is the base and the delta exponent for the rest of the values in the group is computed relative to it, as illustrated in the example of FIG. 9. The bit-width (5) of the delta exponents is dynamically determined per group and is set to the maximum precision of the resulting delta exponents per group. The delta exponent bit-width (3b) is attached to the header of each group as metadata.

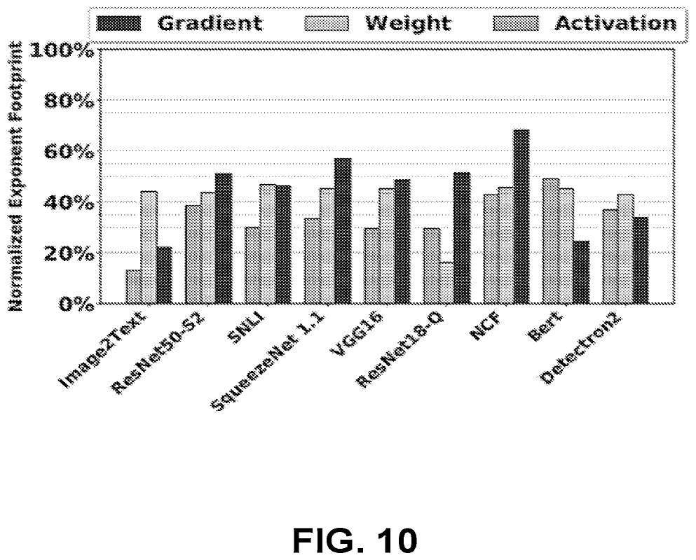

FIG. 10 shows the total, normalized exponent footprint memory savings after base-delta compression. The compression module 130 uses this compression scheme to reduce the off-chip memory bandwidth. Values are compressed at the output of each layer and before writing them off-chip, and they are decompressed when they are read back on-chip.

The present inventors have determined that skipping out-of-bounds terms can be inexpensive. The processing element 122 can use a comparator per lane to check if its current K term lies within a threshold with the value of the accumulator precision. The comparators can be optimized by a synthesis tool for comparing with a constant. The processing element 122 can feed this signal back to a corresponding term encoder indicating that any subsequent term coming from the same input pair is guaranteed to be ineffectual (out-of-bound) given the current e_acc value. Hence, the system 100 can boost its performance and energy-efficiency by skipping the processing of the subsequent out-of-bound terms. The feedback signals indicating out-of-bound terms of a certain lane across the PEs of the same tile column can be synchronized together.

Generally, data transfers account for a significant portion and often dominate energy consumption in deep learning. Accordingly, it is useful to consider what the memory hierarchy needs to do to keep the execution units busy. A challenge with training is that while it processes three arrays W and G, the order in which the elements are grouped differs across the three major computations (Equations 1 through 3 above). However, it is possible to rearrange the arrays as they are read from off-chip. For this purpose, the system 100 can store the arrays in memory using a container of “square” of 32×32 bfloat16 values. This a size that generally matches the typical row sizes of DDR4 memories and allows the system 100 to achieve high bandwidth when reading values from off-chip. A container includes values from coordinates (c,r,k) (channel, row, column) to (c+31,r,k+31) where c and k are divisible by 32 (padding is used as necessary). Containers are stored in channel, column, row order. When read from off-chip memory, the container values can be stored in the exact same order on the multi-banked on-chip buffers. The tiles can then access data directly reading 8 bfloat16 values per access. The weights and the activation gradients may need to be processed in different orders depending on the operation performed. Generally, the respective arrays must be accessed in the transpose order during one of the operations. For this purpose, the system 100 can include the transposer module 132 on-chip. The transposer module 132, in an example, reads in 8 blocks of 8 bfloat16 values from the on-chip memories. Each of these 8 reads uses 8-value wide reads and the blocks are written as rows in an internal to the transposer buffer. Collectively these blocks form an 8×8 block of values. The transposer module 132 can read out 8 blocks of 8 values each and send those to the PE 122. Each of these blocks can be read out as a column from its internal buffer. This effectively transposes the 8×8 value group.

The present inventors conducted examples experiments to evaluate the advantages of the system 100 in comparison to an equivalent baseline architecture that uses conventional floating-point units.

A custom cycle-accurate simulator was developed to model the execution time of the system 100 (informally referred to as FPRaker) and of the baseline architecture. Besides modeling timing behavior, the simulator also modelled value transfers and computation in time faithfully and checked the produced values for correctness against the golden values. The simulator was validated with microbenchmarking. For area and power analysis, both the system and the baseline designs were implemented in Verilog and synthesized using Synopsys' Design Compiler with a 65 nm TSMC technology and with a commercial library for the given technology. Cadence Innovus was used for layout generation. Intel's PSG ModelSim was used to generate data-driven activity factors which was fed to Innovus to estimate the power. The baseline MAC unit was optimized for area, energy, and latency. Generally, it was not possible to optimize for all three; however, in the case of MAC units, it is possible. An efficient bit-parallel fused MAC unit was used as the baseline PE. The constituent multipliers were both area and latency efficient, and are taken from the DesignWare IP library developed by Synopsys. Further, the baseline units was optimized for deep learning training by reducing the precision of its I/O operands to bfloat16 and accumulating in reduced precision with chunk-based accumulation. The area and energy consumption of the on-chip SRAM Global Buffer (GB) is divided into activation, weight, and gradient memories which were modeled using CACTI. The Global Buffer has an odd number of banks to reduce bank conflicts for layers with a stride greater than one. The configurations for both the system 100 (FPRaker) and the baseline are shown in TABLE 2.

TABLE 2

| | FPRaker | Baseline |
|---|---|---|
| Tile Configuration | 8 × 8 | 8 × 8 |
| Tiles | 36 | 8 |
| Total PEs | 2304 | 512 |
| Multipliers/PE | 8 | 8 BFLOAT 16 |
| MACs/cycle | — | 4096 |

| | |
|---|---|
| Scratchpads | 2 KB each |
| Global Buffer | 4 MB × 9 banks |
| Off-chip DRAM Memory | 16 GB 4-channel LPDDR4-3200 |

To evaluate the system 100, traces for one random mini-batch were collected during the forward and backward pass in each epoch of training. All models were trained long enough to attain the maximum top-1 accuracy as reported. To collect the traces, each model was trained on an NVIDIA RTX 2080 Ti GPU and stored all of the inputs and outputs for each layer using Pytorch Forward and Backward hooks. For BERT, BERT-base and the fine-tuning training for a GLUE task were traced. The simulator used the traces to model execution time and collect activity statistics so that energy can be modeled.

Since embodiments of the system 100 process one of the inputs term-serially, the system 100 uses parallelism to extract more performance. In one approach, an iso-compute area constraint can be used to determine how many PE 122 tiles can fit in the same area for a baseline tile.

The conventional PE that was compared against processed concurrently 8 pairs of bfloat16 values and accumulated their sum. Buffers can be included for the inputs (A and B) and the outputs so that data reuse can be exploited temporally. Multiple PEs 122 can be arranged in grid sharing buffers and inputs across rows and columns to also exploit reuse spatially. Both the system 100 and the baseline were configured to have scaled-up GPU Tensor-Core-like tiles that perform 8×8 vector-matrix multiplication where 64 PEs 122 are organized in a 8×8 grid and each PE performs 8 MAC operations in parallel.

Post layout, and taking into account only the compute area, a tile of an embodiment of the system 100 occupies 0.22% the area versus the baseline tile. TABLE 3 reports the corresponding area and power per tile. Accordingly, to perform an iso-compute-area comparison, the baseline accelerator has to be configured to have 8 tiles and the system 100 configured with 36 tiles. The area for the on-chip SRAM global buffer is 344 mm², 93.6 mm², and 334 mm² for the activations, weights, and gradients, respectively.

TABLE 3

| | |
|---|---|
| FPRaker | Baseline |

Area [μm²]

| | | |
|---|---|---|
| Compute Core | 317068 | 1421579 |
| Normalized | 0.22× | 1× |

Power [mW]

| | | |
|---|---|---|
| Compute Core | 109.14 | 475 |
| Normalized | 0.23× | 1× |
| Energy Efficiency | 1.75× | 1× |

FIG. 10 shows performance improvement with the system 100 relative to the baseline. On average the system 100 outperforms the baseline by 1.5×. From the studied convolution-based models, ResNet18-Q benefits the most from the system 100 where the performance improves by 2.04× over the baseline. Training for this network incorporates PACT quantization and as a result most of the activations and weights throughout the training process can fit in 4b or less. This translates into high term sparsity which the system 100 exploits. This result demonstrates that the system 100 can deliver benefits with specialized quantization methods without requiring that the hardware be also specialized for this purpose.

SNLI, NCF, and Bert are dominated by fully connected layers. While in fully connected layers, there is no weight reuse among different output activations, training can take advantage of batching to maximize weight reuse across multiple inputs (e.g., words) of the same input sentence which results in higher utilization of the tile PEs. Speedups follow bit sparsity. For example, the system 100 achieves a speedup of 1.8× over the baseline for SN LI due its high bit sparsity.

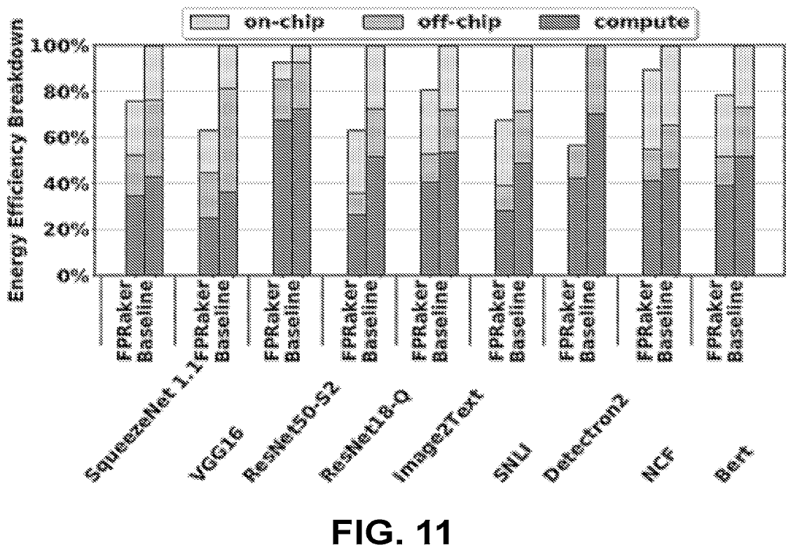

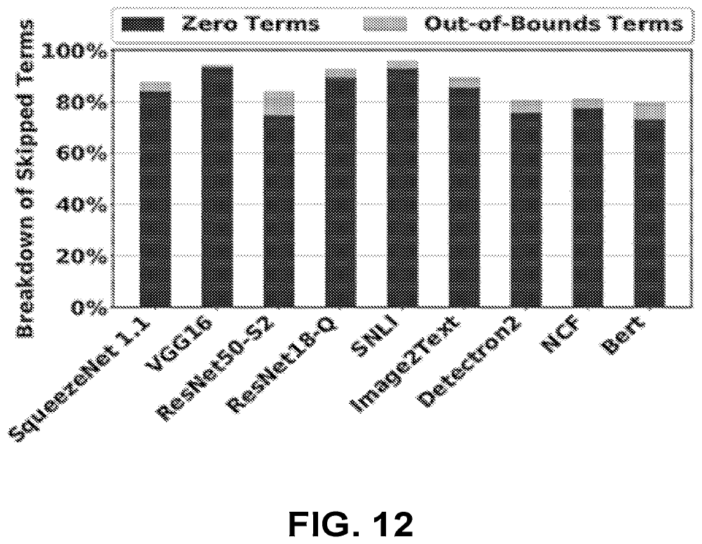

FIG. 11 shows the total energy efficiency of the system 100 over the baseline architecture for each of the studied models. On average, the system 100 is 1.4× more energy efficient compared to the baseline considering only the compute logic and 1.36× more energy efficient when everything is taken into account. The energy-efficiency improvements follow closely the performance benefits. For example, benefits are higher at around 1.7× for SNLI and Detectron2. The quantization in ResNet18-Q boosts the compute logic energy efficiency to as high as 1.97×. FIG. 12 shows the energy consumed by the system 100 normalized to the baseline as a breakdown across three main components: compute logic, off-chip and on-chip data transfers. The system 100 along with the exponent base-delta compression reduce the energy consumption of the compute logic and off-chip memory significantly.

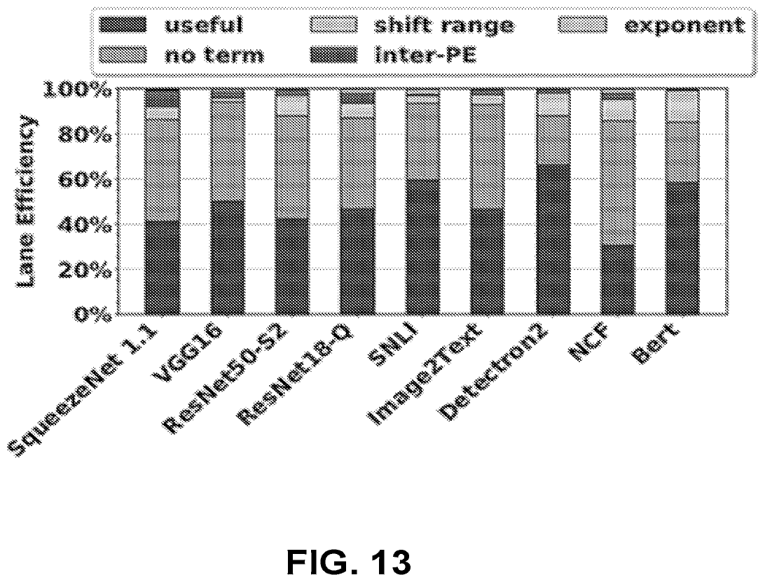

17 [0054] FIG. 13 shows a breakdown of the terms the system 100 skips. There are two cases: 1) skipping zero terms, and 2) skipping non-zero terms that are out-of-bounds due to the limited precision of the floating-point representation. Skipping out-of-bounds terms increases term sparsity for ResNet50-S2 and Detectron2 by around 10% and 5.1%, respectively. Networks with high sparsity (zero values) such as VGG16 and SN LI benefit the least from skipping out-of-bounds terms with the majority of term sparsity coming from zero terms. This is because there are few terms to start with. For ResNet18-Q, most benefits come from skipping zero terms as the activations and weights are effectively quantized to 4b values.

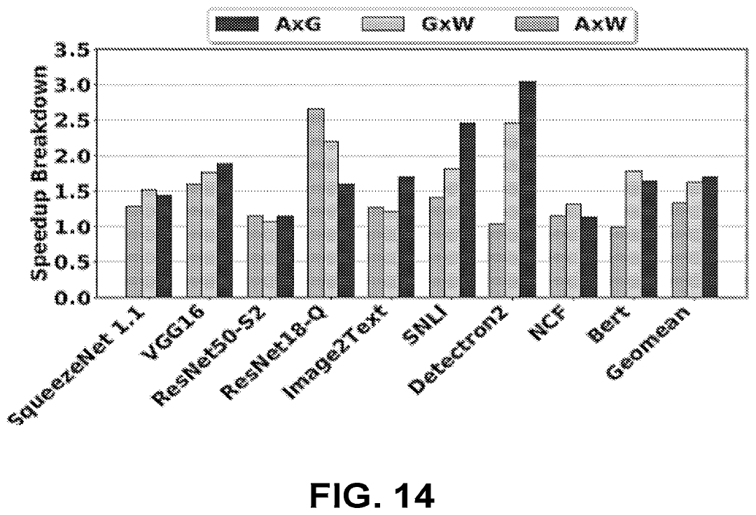

FIG. 14 shows speedup for each of the 3 phases of training: the A×W in forward propagation, and the A×G and the G×W to calculate the weight and input gradients in the backpropagation, respectively. The system 100 consistently outperforms the baseline for all three phases. The speedup depends on the amount of term sparsity, and the value distribution of A, W, and G across models, layers, and training phases. The less terms a value has the higher the potential for the system 100 to improve performance. However, due to the limited shifting that the PE 122 can perform per cycle (up to 3 positions) how terms are distributed within a value impacts the number of cycles needed to process it. This behavior applies across lanes to the same PE 122 and across PEs 122 in the same tile. In general, the set of values that are processed concurrently will translate into a specific term sparsity pattern. In some cases, the system 100 may favor patterns where the terms are close to each other numerically

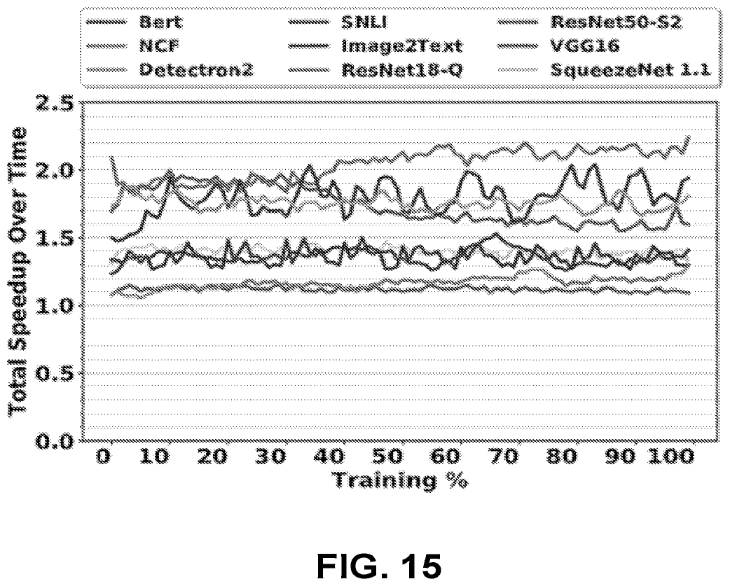

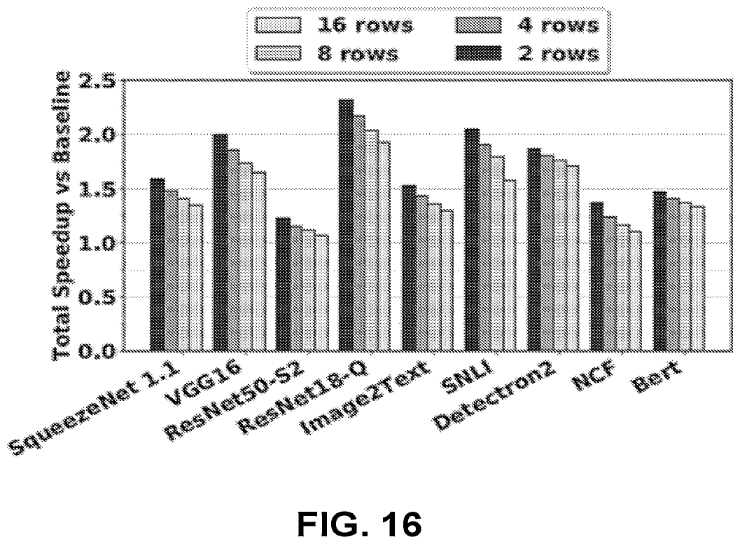

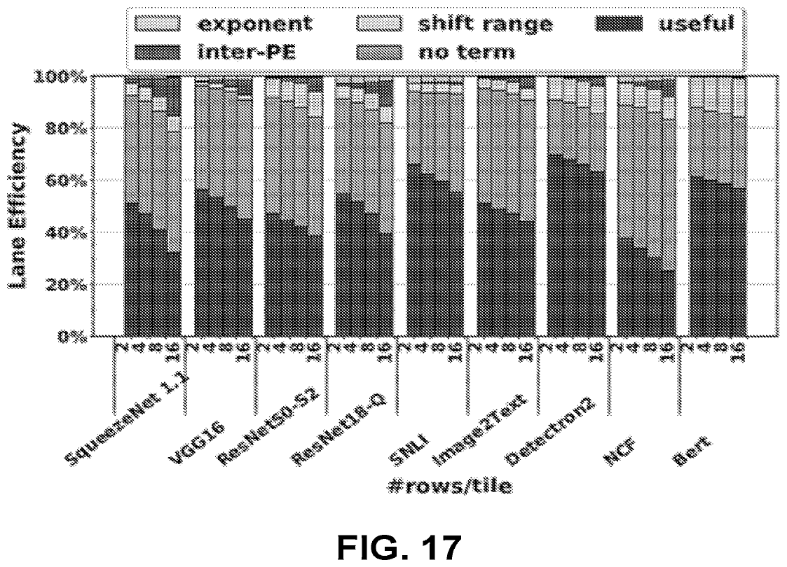

FIG. 15 shows speedup of the system 100 over the baseline over time and throughout the training process for all the studied networks. The measurements show three different trends. For VGG16 speedup is higher for the first 30 epochs after which it declines by around 15% and plateaus. For ResNet18-Q, the speedup increases after epoch 30 by around 12.5% and stabilizes. This can be attributed to the PACT clipping hyperparameter being optimized to quantize activations and weights within 4-bits or below. For the rest of the networks, speeds ups remain stable throughout the training process. Overall, the measurements show that performance of the system 100 is robust and that it delivers performance improvements across all training epochs. Effect of Tile Organization: As shown in FIG. 16, increasing the number of rows per tile reduces performance by 6% on average. This reduction in performance is due to synchronization among a larger number of PEs 122 per column. When the number of rows increases, more PEs 122 share the same set of A values. An A value that has more terms than the others will now affect a larger number of PE 122 which will have to wait to finish processing. Since each PE 122 processes a different combination of input vectors, each can be affected differently by intra-PE 122 stalls such as “no term” stalls or “limited shifting” stalls. FIG. 17 shows a breakdown of where time goes in each configuration. It can be seen that the stalls for the inter-PE 122 synchronization increase and so do those for stalling for other lanes (“no term”).

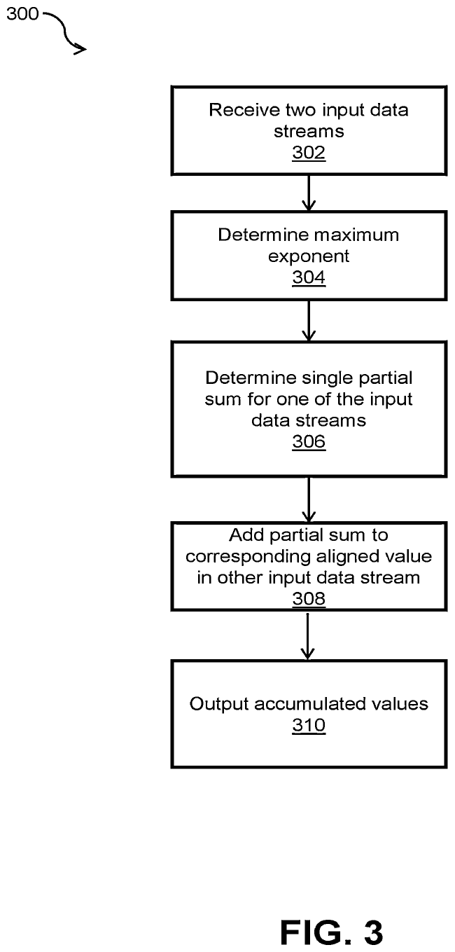

FIG. 3 illustrates a flowchart for a method 300 for accelerating multiply-accumulate units (MAC) during training of deep learning networks, according to an embodiment.

At block 302, the input module 120 receives two input data streams to have MAC operations performed on them, respectively A data and B data.

At block 304, the exponent module 124 adds exponents of the A data and the B data in pairs to produce product exponents determines a maximum exponent using a comparator.

At block 306, the reduction module 126 determines a number of bits by which each B significand has to be shifted prior to accumulation by adding product exponent deltas to the corresponding term in the A data and uses an adder tree to reduce the B operands into a single partial sum.

At block 308, the accumulation module 128 adds the partial sum to a corresponding aligned value using the maximum exponent to determine accumulated values.

At block 310, the accumulation module 128 outputs the accumulated values.

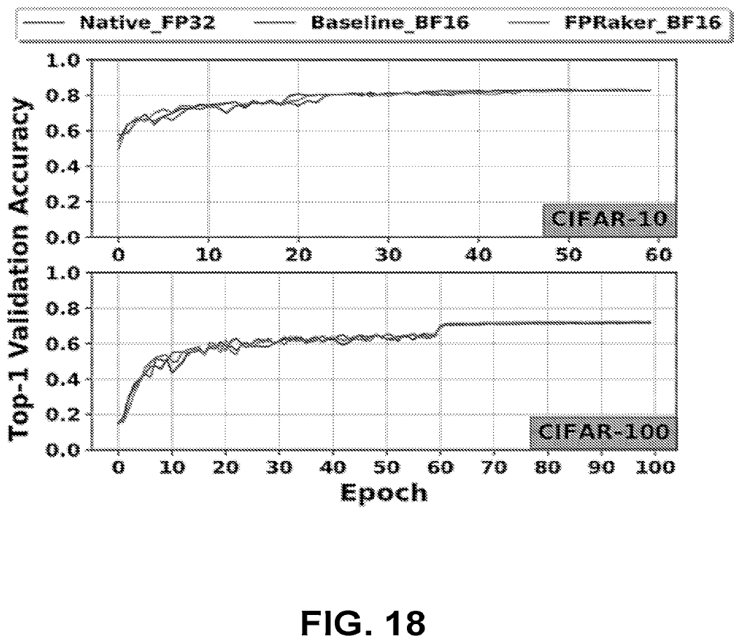

To study the effect of training with FPRaker on accuracy, the example experiments emulated the bit-serial processing of PE 122 during end-to-end training in PlaidML, which is a machine learning framework based on OpenCL compiler at the backend. PlaidML was forced to use the mad( ) function for every multiply-add during training. The mad( ) function was overridded with the implementation of the present disclosure to emulate the processing of the PE. ResNet18 was trained on CIFAR-10 and CIFAR-100 datasets. The first line shows the top-1 validation accuracy for training natively in PlaidML with FP32 precision. The baseline performs bit-parallel MAC with I/O operands precision in bfloat16 which is known to converge and supported in the art. FIG. 18 shows that both emulated versions converge at epoch 60 for both datasets with accuracy difference within 0.1% relative to the native training version. This is expected since the system 100 skips ineffectual work, i.e., work which does not affect final result in the baseline MAC processing.

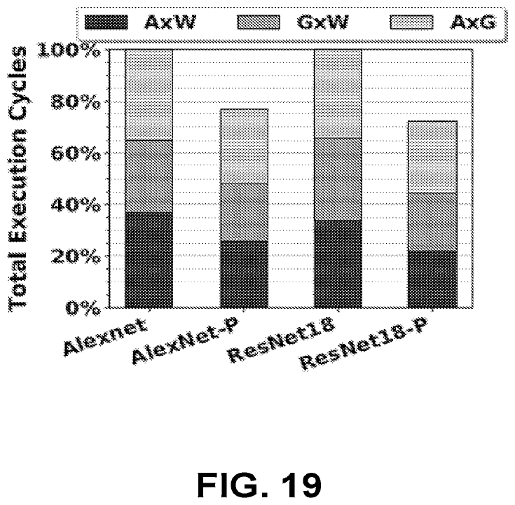

Conventionally, training uses bfloat16 for all computations. In some cases, mixed datatyPE 122 arithmetic can be used where some of the computations used fixed-point instead. In other cases, floating-point can be used where the number of bits used by the mantissa varies per operation and per layer. In some cases, the suggested mantissa precisions can be used while training AlexNet and ResNet18 on Imagenet. FIG. 19 shows the performance of the system 100 following this approach. The system 100 can dynamically take advantage of the variable accumulator width per layer to skip the ineffectual terms mapping outside the accumulator boosting overall performance. Training ResNet18 on ImageNet with per layer profiled accumulator width boosts the speedup of the system 100 by 1.51×, 1.45× and 1.22× for A×W, G×Wand A×G, respectively. Achieving an overall speedup of 1.56× over the baseline compared to 1.13× that is possible when training with a fixed accumulator width. Adjusting the mantissa length while using a bfloat16 container manifests itself a suffix of zero bits in the mantissa.

Advantageously, the system 100 can perform multiple multiply-accumulate floating-point operations that all contribute to a single final value. The processing element 122 can be used as a building block for accelerators for training neural networks. The system 100 takes advantage of the relatively high term level sparsity that all values exhibit during training. While the present embodiments described using the system 100 for training, it is understood that it can also be used for inference. The system 100 may be particularly advantageous for models that use floating-point; for example, models that process language or recommendation systems.

Advantageously, the system 100 allows for efficient precision training. Different precision can be assigned to each layer during training depending on the layer's sensitivity to quantization. Further, training can start with lower precision and increase the precision per epoch near conversion. The system 100 can allow for dynamic adaptation of different precisions and can boost performance and energy efficiency.

The system 100 can be used to also perform fixed-point arithmetic. As such, it can be used to implement training where some of the operations are performed using floating-point and some using fixed-point. To perform fixed-point arithmetic: (1) the exponents are set to a known fixed value, typically the equivalent of zero, and (2) an external overwrite signal indicates that the significands do not contain an implicit leading bit that is 1. Further, since the operations performed during training can be a superset of the operations performed during inference, the system 100 can be used for inference.

Although the invention has been described with reference to certain specific embodiments, various modifications thereof will be apparent to those skilled in the art without departing from the spirit and scope of the invention as outlined in the claims appended hereto.

1. A method for accelerating multiply-accumulate (MAC) floating-point units during training or inference of deep learning networks, the method comprising:
receiving a first input data stream A and a second input data stream B;
adding exponents of the first data stream A and the second data stream B in pairs to produce product exponents;
determining a maximum exponent using a comparator;
determining a number of bits by which each significand in the second data stream has to be shifted prior to accumulation by adding product exponent deltas to the corresponding term in the first data stream and using an adder tree to reduce the operands in the second data stream into a single partial sum;
adding the partial sum to a corresponding aligned value using the maximum exponent to determine accumulated values; and
outputting the accumulated values.

2. The method of claim 1, wherein determining the number of bits by which each significand in the second data stream has to be shifted prior to accumulation includes skipping ineffectual terms mapped outside a defined accumulator width.

3. The method of claim 1, wherein each significand comprises a signed power of 2.

4. The method of claim 1, wherein adding the exponents and determining the maximum exponent are shared among a plurality of MAC floating-point units.

5. The method of claim 1, wherein the exponents are set to a fixed value.

6. The method of claim 1, further comprising storing floating-point values in groups, and wherein the exponents deltas are encoded as a difference from a base exponent.

7. The method of claim 6, wherein the base exponent is a first exponent in the group.

8. The method of claim 1, wherein using the comparator comprises comparing the maximum exponent to a threshold of an accumulator bit-width.

9. The method of claim 8, wherein the threshold is set to ensure model convergence.

10. The method of claim 9, wherein the threshold is set to within 0.5% of training accuracy.

11. A system for accelerating multiply-accumulate (MAC) floating-point units during training or inference of deep learning networks, the system comprising one or more processors in communication with data memory to execute:
an input module to receive a first input data stream A and a second input data stream B;
an exponent module to add exponents of the first data stream A and the second data stream B in pairs to produce product exponents, and to determine a maximum exponent using a comparator;
a reduction module to determine a number of bits by which each significand in the second data stream has to be shifted prior to accumulation by adding product exponent deltas to the corresponding term in the first data stream and use an adder tree to reduce the operands in the second data stream into a single partial sum; and
an accumulation module to add the partial sum to a corresponding aligned value using the maximum exponent to determine accumulated values, and to output the accumulated values.

12. The system of claim 11, wherein determining the number of bits by which each significand in the second data stream has to be shifted prior to accumulation includes skipping ineffectual terms mapped outside a defined accumulator width.

13. The system of claim 11, wherein each significand comprises a signed power of 2.

14. The system of claim 11, wherein the exponent module, the reduction module, and the accumulation module are located on a processing unit and wherein adding the exponents and determining the maximum exponent are shared among a plurality of processing units.

15. The system of claim 14, wherein the plurality of processing units are configured in a tile arrangement.

16. The system of claim 15, wherein processing units in the same column share the same output from the exponent module and processing units in the same row share the same output from the input module.

17. The system of claim 11, wherein the exponents are set to a fixed value.

18. The system of claim 11, further comprising storing floating-point values in groups, and wherein the exponents deltas are encoded as a difference from a base exponent, and wherein the base exponent is a first exponent in the group.

19. The system of claim 11, wherein using the comparator comprises comparing the maximum exponent to a threshold of an accumulator bit-width, where the threshold is set to ensure model convergence.

20. The system of claim 19, wherein the threshold is set to within 0.5% of training accuracy.
